(19) United States
(12) Patent Application Publication
(10) Pub. No.: US 2025/0273842 A1
(43) Pub. Date: Aug. 28, 2025

(54) ANTENNA DEVICE FOR MOTOR VEHICLE, RADAR DEVICE, COMMUNICATION DEVICE, ASSISTANCE SYSTEM, AND METHOD

(71) Applicants: VOLKSWAGEN AKTIENGESELLSCHAFT, Wolfsburg (DE); AUDI AG, Ingolstadt (DE)

(72) Inventors: Heiko Gustav KURZ, Hannover (DE); Heiko SCHRÖDER, Meinersen (DE); Marc-Michael MEINECKE, Sassenburg (DE); Niels KOCH, Ingolstadt (DE)

(21) Appl. No.: 18/704,984

(22) PCT Filed: Oct. 25, 2022
(86) PCT No.: PCT/EP2022/079765

§ 371 Date: Apr. 26, 2024

(30) Foreign Application Priority Data
Oct. 28, 2021 (DE) 10 2021 128 147.4

(51) Int. Cl. H01Q 1/12; G01S 13/931

(52) U.S. Cl. CPC H01Q 1/1271; G01S 13/931; G01S 2013/93276

(57) ABSTRACT

An antenna device for a transportation vehicle for transmitting and/or receiving electromagnetic radiation having at least one first antenna element to transmit and/or receive electromagnetic radiation based on liquid crystal technology and an electronic computing device to generate a control signal for the at least first antenna element. The antenna device has at least one second antenna element to transmit and/or receive electromagnetic radiation based on liquid crystal technology, wherein the first antenna element and/or the second antenna element is activated for transmission and/or receiving purposes based on the control signal. Also disclosed is a communication device, a radar device, an assistance system, and a method.

### PRIORITY CLAIM

This patent application is a U.S. National Phase of International Patent Application No. PCT/EP2022/079765, filed 25 Oct. 2022, which claims priority to German Patent Application No. 10 2021 128 147.4, filed 28 Oct. 2021, the disclosures of which are incorporated herein by reference in their entireties.

### SUMMARY

Illustrative embodiments relate to an antenna device for a transportation vehicle for emitting and/or receiving electromagnetic radiation, comprising at least one first antenna element configured to emit and/or receive electromagnetic radiation based on a liquid crystal technology, and comprising an electronic computing device configured to generate a control signal for the at least first antenna element. Further, the illustrative embodiments relate to a communication device, a radar device, an assistance system, as well as a method.

### BRIEF DESCRIPTION OF THE DRAWINGS

Exemplary embodiments are described below with reference to drawings, in which:

FIG. 1 is a schematic front view of an exemplary embodiment of a transportation vehicle comprising a disclosed embodiment of an assistance system comprising a disclosed embodiment of a radar device and/or a disclosed embodiment of a communication device comprising a disclosed embodiment of an antenna device;

FIG. 2 is a schematic block diagram according to an exemplary embodiment of an antenna element;

FIG. 3 is a further schematic block diagram according to an exemplary embodiment of an antenna element;

FIG. 4 is a further schematic block diagram according to an exemplary embodiment of an antenna element;

FIG. 5 is a still further schematic block diagram according to an exemplary embodiment of an antenna element;

FIG. 6 is a still further schematic block diagram according to an exemplary embodiment of an antenna element;

FIG. 7 is a schematic block diagram according to an exemplary embodiment of the antenna device;

FIG. 8 is a further schematic block diagram according to an exemplary embodiment of the antenna device; and

FIG. 9 is a schematic side view according to an exemplary embodiment of the antenna device.

### DETAILED DESCRIPTION

From the prior art antenna devices configured for receiving/transmitting electromagnetic radiation are already known. For example, these antenna arrays may be provided for a radar sensor device or a communication device. These antenna arrays are, in particular, static superstructures that cannot be changed in an adaptive manner and these involve great effort in the manufacture and integration within the transportation vehicle. Further, also a covered installation for large distributed antenna devices is not possible.

Document US 2009/051620 A1 discloses a transparent antenna for a display.

Document WO 2018/105170 A1 describes a transparent display system as well as a transparent display device.

Document US 2002/152606 A1 discloses an imprinted antenna for a wireless mobile personal end device.

Disclosed embodiments provide an antenna device, a communication device, a radar device, an assistance system, as well as a method for operating an antenna device, by which electromagnetic radiation may be emitted and/or received in an improved way.

This is achieved by an antenna device, a communication device, a radar device, an assistance system, as well as a method.

At least one exemplary embodiment relates to an antenna device for a transportation vehicle for emitting and/or receiving electromagnetic radiation, comprising at least one first antenna element, which is configured to emit and/or receive electromagnetic radiation on the basis of a liquid crystal technology, and comprising an electronic computing device, which is configured to generate a control signal for the at least first antenna element.

It is envisaged that the antenna device comprises at least one second antenna element, which is configured to emit and/or receive electromagnetic radiation on the basis of the liquid crystal technology, wherein, based on the control signal the first antenna element and/or the second antenna element are activated for emitting and/or receiving.

In particular, thus an antenna device is suggested, which is capable of being configured in a flexible manner and may be transparent for the radiation in the visible spectral range. The antenna device may, for example, be employed for an automobile radar application, which requires large-surface, adaptively reconfigurable antenna structures to refine the resolution capacity and may be manufactured and installed in a covered way, in particular, not visible to the human eye, or transparent for the visible spectral range.

According to the prior art conventional antenna arrays as static superstructures may not be adaptively modified and thus involve great effort in the manufacture and integration in the transportation vehicle. A covered installation for large and distributed arrays as a rule is therefore not possible.

In particular, thus it is suggested for improvement that both for the first antenna element as well as for the second antenna element the so-called liquid crystal technology, which may also be referred to as LCD, is used for the modulation of electromagnetic radiation in the millimeter wave range. For example, the same may conduct a radiation with 77 Gigahertz, a frequency modulation, a pulse width modulation, an amplitude modulation, as well as a phase modulation. The first antenna element and the second antenna element in this connection may be configured as so-called elementary antenna both as receiver and as emitter. Then, in turn, the interconnection of the at least two antenna elements to the antenna device is effected. It may then be possible that, for example, by electronic-photonic radar chips (EPIC chips) the antenna elements, in turn, are electrically connected. For example, the control signal of the electronic computing device may be transmitted via the electronic-photonic radar chips from the electronic computing device to the antenna elements. The electronic computing device may then, in turn, be configured as central data processing device for signal processing and be configured both for receiving data and their evaluation as well as for controlling the antenna elements. In particular, the electromagnetic radiation may then, in turn, be emitted into an environment of the transportation vehicle. Should the electromagnetic radiation be emitted as radar radiation, thereby the environment may be captured and the evaluated environment be provided in a so-called environmental model.

In particular, by the freely configurable antenna array of the at least two antenna elements a simple switching between various configurations of the antenna device in an individual setup may be realized so that both long-range, mid-range, or short-range combinations are possible.

In particular, disclosed embodiments solve the problem that, in the case of a highly automated operation of a transportation vehicle, an angle resolution in the 0.1 degree range is necessary. The antenna size resulting therefrom amounts to, for instance, 1.2 meter. For such antenna sizes possibly no suitable large surfaces on the vehicle body shell are available. The disclosed solution comprises that the antenna device is applied to a large, in particular, more or less plane, crystal surface, for example, the windshield. The antenna device therein is operated by the liquid crystal technology. The liquid crystal technology in this connection allows for the antenna device to be transparent, for example, in the visible wave range. Thus, it is hardly perceivable for human eyes. The view through the windshield accordingly is possible in a nearly undisturbed manner. An integration at different installation locations, such as, for example, the bumper or the roof edge, is equally possible.

Further, the antenna elements, which may be executed in patch configuration, may also be controlled by an applied voltage, in particular, in analogy to the LCD display. Controlled elements are active antenna elements, the elements that are not controlled in the case of the antenna quasi do not appear. Thus, the possibility of an activation/deactivation of individual antenna elements, for example, during the radar measuring, is provided. This means that the antenna directivity diagrams may be controlled almost without any delay. This is of enormous significance for the perception of the environment of the transportation vehicle.

Moreover, this kind of antenna element offers the possibility of self-calibration during operation. Possible distortions of the antenna elements, which may derive from thermal effects, lead to a distortion of the perceived scene. These distortions may be compensated for. With the aid of the differentially controllable antenna elements the exact positions of the antenna elements may be determined.

According to an exemplary embodiment at least the first antenna element and the second antenna element are capable of being activated separately from each other. For example, this may be realized by the different control of the corresponding EPIC chips, that is the electronic-photonic chips. In particular, also different control signals, both for the first antenna element as well as for the second antenna element may be generated. Thus, the antenna device may control the first antenna element and the second antenna element separately from each other, whereby different directivity diagrams may be generated.

Further, it has proven benefits, if the antenna device comprises a multitude of further antenna elements, wherein the multitude of further antenna elements is capable of being activated based on the control signal. In particular, the antenna elements may be arranged substantially adjacent to one another. For example, the antenna device may comprise three antenna elements, four antenna elements, five antenna elements, six antenna elements, or more than six antenna elements. The respective antenna elements are then capable of being activated or deactivated separately from each other. Thus, a predetermined directivity diagram may be generated.

In a further exemplary embodiment at least the first antenna element and/or the second antenna element are substantially transparent. By the transparent embodiment of the antenna elements it is facilitated that, for example, the antenna device may also be accommodated in corresponding window panes of the transportation vehicle, without substantially impairing the field of vision for the human eye. In particular, the antenna elements are configured to be substantially transparent at least for the human eye. By the liquid crystal technology the transparent design is possible.

It is further beneficial if the antenna device is configured to be at least in part in a window pane of the transportation vehicle. In particular, the window pane offers a large surface to provide a corresponding antenna device with a multitude of antenna elements. Thus, a large-surface capturing of the environment may be realized.

According to a further disclosed embodiment the antenna device is configured to be at least in part in a windshield and/or a rear window and/or a side window and/or a roof window. Thereby it is facilitated that various window panes of the transportation vehicle may be used to accommodate the antenna device. In particular, by the substantially transparent design an occupant of the transportation vehicle may still look through the corresponding window panes and perceive the environment.

In a further disclosed embodiment the antenna device is configured as part of a radar device of the transportation vehicle and/or as part of a communication device of the transportation vehicle. In particular, based on various control signals the antenna device may be configured both as radar device and as communication device. For example, on the basis of the communication device a communication with, for example, a satellite, may be realized. On the basis of the radar device, in particular, an environment of the transportation vehicle may be captured and the evaluation for an at least partially automated operation of the transportation vehicle be performed.

It has further proven to be beneficial if based on an activation of at least the first antenna element and/or the second antenna element a predetermined radiation characteristic and/or receiving characteristic is set. In particular, based on the various antenna elements that can be activated a corresponding radiation characteristic may be realized. For example, merely the first antenna element may be configured for transmitting, while the second antenna element is deactivated. Thereby only via the first antenna element the electromagnetic radiation is emitted. Thus, a directed emitting of the electromagnetic radiation may be realized.

According to a further exemplary embodiment, based on the control signal and/or based on a predetermined orientation of the liquid crystals in the at least first antenna element and/or the second antenna element a radiation direction for transmitting and/or a receiving direction for receiving the electromagnetic radiation is set. In particular, thus a beam forming may be realized. In particular, by the orientation of the liquid crystals thus the radiation characteristic may be influenced. Should the antenna device be configured on an inclined plane, for example, an inclined windshield, by the orientation of liquid crystals within the antenna device also in the case of the inclined plane still a radiation that is substantially in parallel to the ground may be realized since the liquid crystals are orientated accordingly and the radiation or the receiving is merely facilitated in the predetermined direction. Thus, the antenna device is also employable, for example, in inclined planes, whereby a highly flexible antenna device may be provided for installation in the transportation vehicle.

It has further proven beneficial if based on an installation location of the at least first antenna element and/or the second antenna element the radiation direction and/or receiving direction is predetermined. In particular, the radiation direction and/or the receiving direction is dependent on an orientation of the first antenna element and/or the second antenna element in relation to a ground, on which the transportation vehicle is located.

It has further proven beneficial if based on the purpose of employment of the antenna device the radiation direction or receiving direction is predetermined. Should the antenna device be configured for a communication device, the radiation of the electromagnetic radiation may essentially be effected in parallel to a vehicle vertical axis. Should the purpose of employment of the antenna device be configured for a radar sensor device, a radiation direction or a receiving direction, respectively, may be effected substantially in parallel to a longitudinal direction of the transportation vehicle.

A further disclosed embodiment relates to a communication device comprising at least one antenna device according to the an exemplary embodiment.

Further, the disclosed embodiment relates to a radar device comprising at least one antenna device according to the an exemplary embodiment.

A still further disclosed embodiment relates to an assistance system comprising at least one communication device and/or comprising a radar device. In particular, the assistance system may comprise both the communication device as well as the radar device, wherein by the communication device electromagnetic radiation with a first wavelength is emitted into/received from the environment and by the radar device electromagnetic radiation with a second wavelength that is different from the first wavelength is emitted into/received from the environment. The assistance system may then be configured both for communicating as well as for capturing the environment. In particular, the assistance system may be configured for an at least partially automatically operated transportation vehicle or for a fully automatically operated transportation vehicle.

A still further disclosed embodiment relates to a method for operating an antenna device for a transportation vehicle for emitting and/or receiving electromagnetic radiation, comprising at least one first antenna element, by which on the basis of a liquid crystal technology electromagnetic radiation is emitted and/or received, and with an electronic computing device, by which a control signal for the at least first antenna element is generated.

In this connection it is envisaged that the antenna device comprises at least one second antenna element by which electromagnetic radiation is emitted and/or received on the basis of the liquid crystal technology, wherein, based on the control signal the first antenna element and/or the second antenna element are activated for emitting and/or receiving.

Exemplary embodiments of the antenna device are to be considered as beneficial embodiments of the communication device, the radar device, the assistance system, as well as the method. In particular, the antenna device, the communication device, the radar device, as well as the assistance system have substantive features, which are necessary for performing a method.

The electronic computing device may comprise processors as well as circuitry, in particular, integrated circuits, to be able to perform a corresponding method.

The method is a computer-implemented method. Therefore, a further exemplary embodiment relates to a computer program product comprising program code methods or mechanisms, which cause an electronic computing device, if the program code methods or mechanisms are executed by the electronic computing device, to perform a disclosed method. A still further disclosed embodiment, therefore, also relates to a computer-readable storage medium comprising the computer program product.

The disclosure also includes developments of the disclosed method, which comprise features as they have already been described in connection with the developments of the disclosed antenna device. For this reason, the corresponding developments of the disclosed method are not described once again.

The disclosure also comprises the combinations of the method of the described embodiments.

In the exemplary embodiments, the described components in each case represent individual features of the disclosure that are to be considered independently of each other and which in each case further develop the disclosure independently of each other and thus, also individually or in different combinations than the one disclosed. Moreover, the described embodiments are also capable of being supplemented by further ones of the already described features.

In the figures elements having the same function are each equipped with the same reference signs.

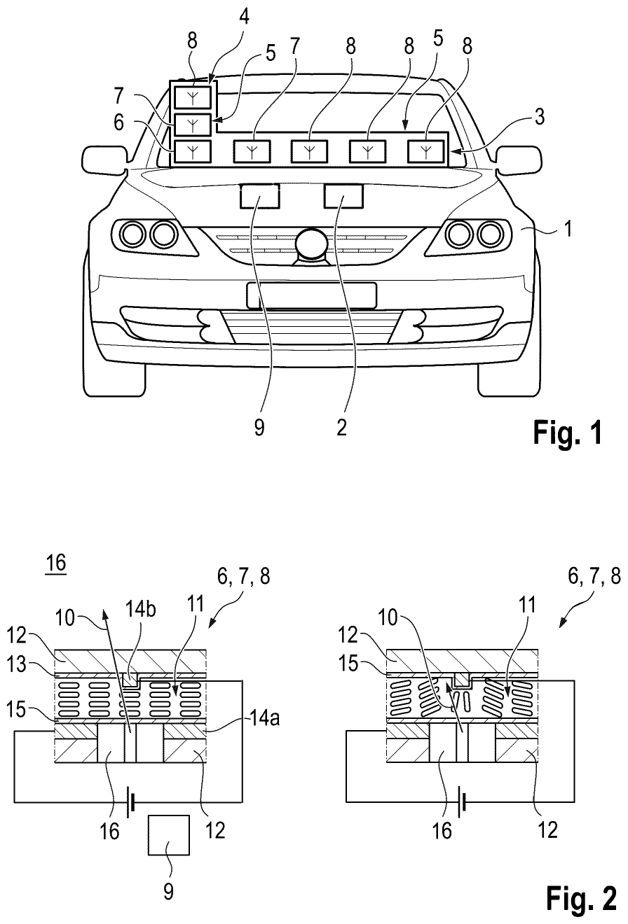

FIG. 1 shows a schematic front view of an embodiment of a transportation vehicle 1, comprising an embodiment of an assistance system 2. The assistance system 2 in the present embodiment may comprise a radar device 3 as well as, alternatively or additionally, a communication device 4. The radar device 3 as well as the communication device 4, in turn, comprise an antenna device 5 each.

The antenna device 5 comprises at least one first antenna element 6 as well as at least one second antenna element 7. In the present case both for the radar device 3 as well as for the communication device 4 further antenna elements 8 are shown.

The antenna device 5 comprises at least further an electronic computing device 9.

The antenna device 5 is configured to emit and/or receive electromagnetic radiation 10 (FIG. 2).

In particular, it is shown that the antenna device 5 at least in part is configured in a window pane of the transportation vehicle 1. The antenna device 5 in the present case is configured as a windshield of the transportation vehicle 1. Alternatively or additionally, the antenna device 5 may also be configured in a rear window and/or in a side window and/or in a roof window of the transportation vehicle 1.

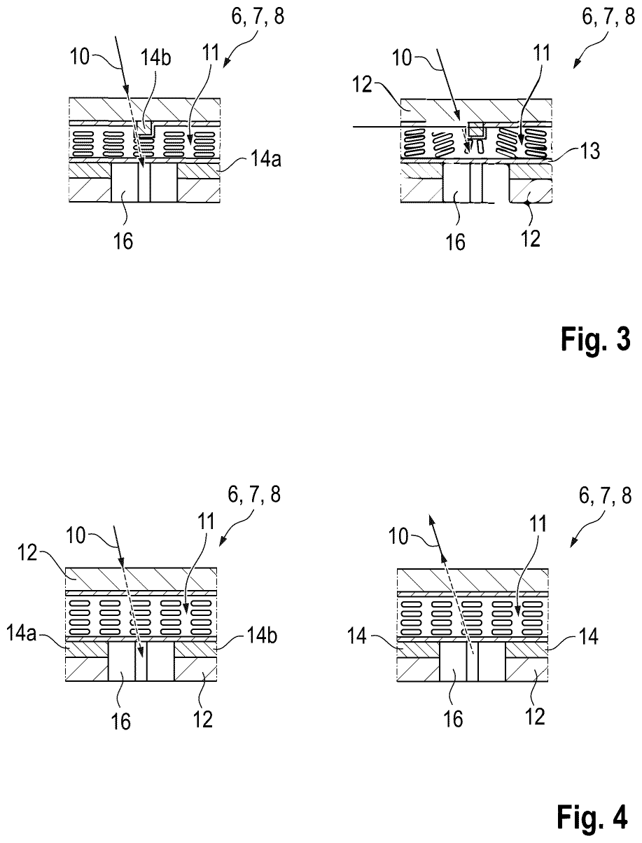

FIG. 2 shows a schematic block diagram according to an embodiment of an antenna element 6, 7, 8. In the present case it is shown that by the antenna device 5 or by the antenna elements 6, 7, 8 electromagnetic radiation 10 may be emitted or, as represented in FIG. 3, electromagnetic radiation 10 may be received. The antenna element 6, 7, 8 is configured based on a liquid crystal technology 11 for emitting and/or receiving electromagnetic radiation 10.

FIG. 2 thus shows the setup of an antenna element 6, 7, 8 on the basis of the liquid crystal technology 11 according to an embodiment. In FIG. 2, an antenna element 6, 7, 8 for emitting the electromagnetic radiation 10 is shown. In particular, thus a high-frequency antenna 16 in the millimeter spectral range is shown, which is applied to a substrate 12 and emits the electromagnetic radiation 10 in the millimeter wave range. The emitted radiation may be p-polarized and transmitted by the first polarizer 13 and by the subsequent layer with the liquid crystal technology 11. If there is no voltage applied between the bottom and the top electrodes 14a, 14b, by the orientation of the molecules of the liquid crystals no polarization rotation is induced so that the radiation is emitted by the subsequent second polarizer 15 and emitted into an environment 16. This is shown in the left side of FIG. 2. In the right side of FIG. 2 it is shown that between the electrodes 12 a voltage is applied. By the electric field of the electrode voltage the liquid crystals are aligned and the impinging p-polarized radiation undergoes a polarization rotation/filtering through the corresponding liquid crystal layer so that the radiation emitted by the antenna element 6, 7, 8 is absorbed by the second polarizer 15.

In particular, thus on the left side of FIG. 2 an activated antenna element 6, 7, 8 is shown and on the right side of FIG. 2 a deactivated antenna element 6, 7, 8 is shown. In particular, thus the high-frequency antenna 16 is applied to the substrate 12 in the millimeter spectral range and emits radiation in the millimeter wave range. The emitted radiation may, for instance, be p-polarized and emitted, which is represented on the left side. On the right side the electromagnetic radiation 10 is filtered.

FIG. 3 shows a further schematic block diagram according to an embodiment of the antenna elements 6, 7, 8, as they are already shown in FIG. 2. In the present embodiment, in particular, the receiving of electromagnetic radiation 10 is shown. On the left side of FIG. 3 the antenna element 6, 7, 8 is located ready for reception, meaning it is activated, and on the right side the antenna element 6, 7, 8 in the deactivated state is located, whereby no electromagnetic radiation 10 is received. In analogy to FIG. 2 by applying a voltage between the electrodes 14a, 14b a polarization rotation is indicated in the incident p-polarized radiation so that this is absorbed by the polarizer, according to the right configuration, that is the first polarizer 13, and does not reach the high-frequency antenna 16. By temporal switching of the voltage various polarization rotations may be induced so that the polarization of the incident wave may be determined.

FIG. 4 shows a further schematic block diagram according to an embodiment of an antenna element 6, 7, 8. In particular, FIG. 4 shows a further embodiment. By employing different potentials of the electrodes 14a, 14b in the bottom substrate 12 the top electrode 14a, 14b may be omitted. In particular, by applying a voltage between the electrode 14a and 14b the liquid crystal molecules are aligned and a polarization rotation/filtering is induced, which switches the transmission and receiver channels on and off. In particular, in the present case on the left side an active receiving element is shown and on the right side an active emitter element is shown.

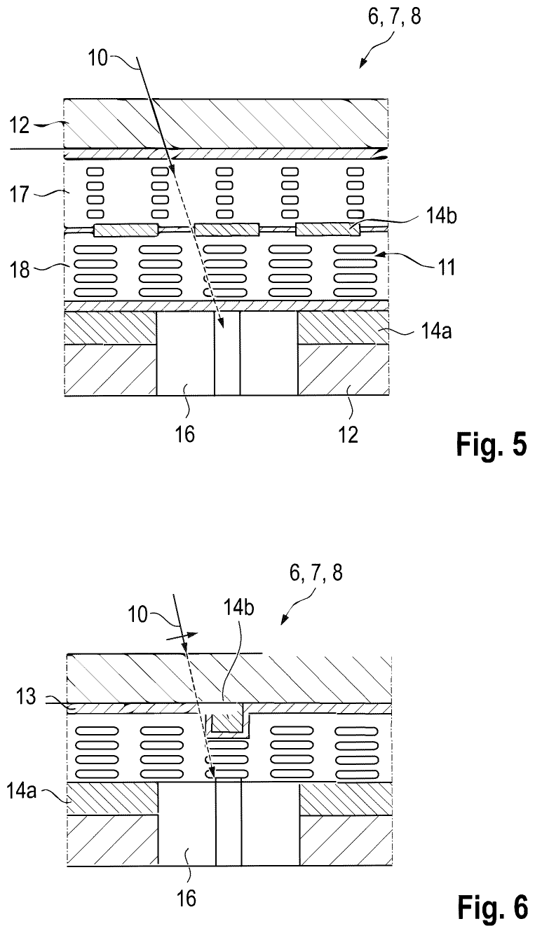

FIG. 5 shows a further schematic embodiment in a block diagram of the antenna element 6, 7, 8. In the present embodiment, several layers of liquid crystals arranged in orthogonal manner relative to each other for polarization-sensitive detection are represented. Employing several layers allows for an increase of the signal-to-noise-ratio whilst simultaneously constructing polarization ratios.

In particular, thus a multi-layer LC design for polarization-sensitive detection is shown. Two LC layers 17, 18 aligned orthogonally relative to each other allow for decomposing the incident unpolarized radiation into the spectral components by connecting independently of each other. The s-polarized portion of the incident radiation after penetrating the first LC layer 17 undergoes a polarization rotation/filtering whilst the p-polarized portion remains unchanged. Thus the electromagnetic wave transmits through the second LC layer 18 and is detected by the high-frequency antenna 16. By suitable switching of the two layers the polarization ratio of the unpolarized wave may be concluded. Such an arrangement facilitates detecting unpolarized radiation without sensitivity loss.

FIG. 6 shows a further schematic block diagram according to an embodiment of an antenna element 6, 7, 8. In the present case it is shown that by employing a polarization-sensitive antenna the second polarizer 15 may be omitted. In particular, by the intrinsic polarization sensitivity of the high-frequency antenna 16 the second polarization layer may be saved.

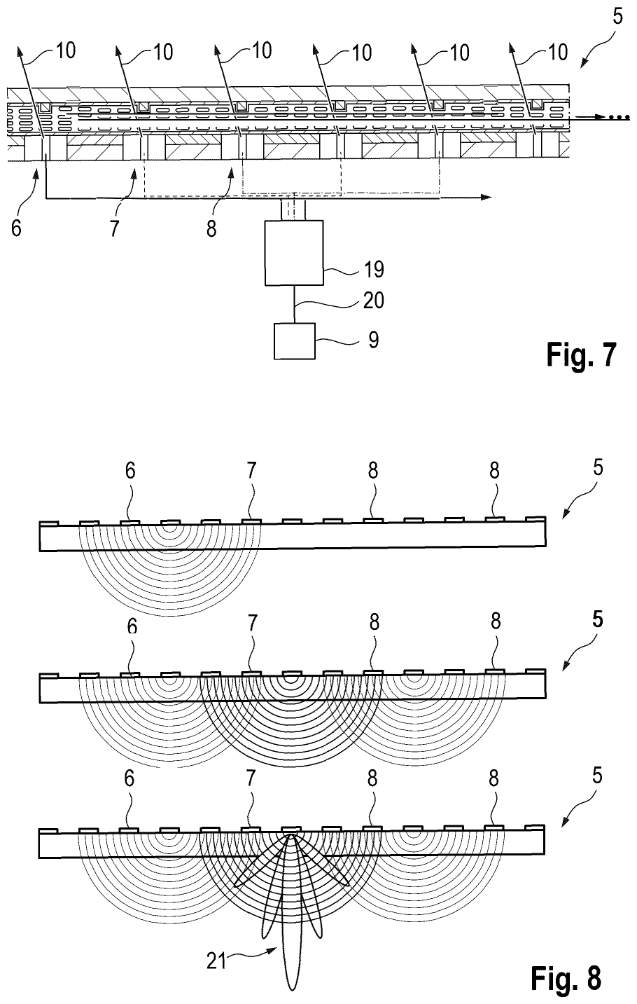

FIG. 7 shows a schematic block diagram according to an embodiment of the antenna device 5. In particular, it is shown that a plurality of antenna elements 6, 7, 8 may be configured adjacent to one another. In particular, thus FIG. 7 shows that the antenna elements 6, 7, 8 in one-dimensional direction, two-dimensional direction, or also three-dimensional direction may be configured for forming the overall array, also for forming the antenna device 5. The antenna elements 6, 7, 8 may then be controlled by a so-called EPIC chip 19, both for transmitting and for receiving. Data transmission is effected by optical fiber 20 between the EPIC chip 19 and the central electronic computing device 9. In FIG. 7 it is shown that the antenna device 5 is configured for emitting electromagnetic beams 10. In particular, the antenna elements 6, 7, 8, in particular, the plurality of antenna elements 6, 7, 8, is connected to a corresponding output of the EPIC chip 19. Various subgroups of the antenna elements 6, 7, 8 are connected to various outputs of the EPIC chip 19. By switching the outputs of the EPIC chip 19 various subgroups may be switched on and off and thus the antenna diagram or a radiation characteristic 21 (FIG. 8) may be changed. Thus, it may be switched between long range, mid range, and short range combination of the antenna device 5.

Thus, it may be envisaged that at least the first antenna element 6 and the second antenna element 7 are capable of being activated separately from each other.

According to FIG. 7, in particular, control signals as well as the entire signal processing and evaluation is performed by the electronic computing device 9. Each transmission and/or receiving module, that is the antenna elements 6, 7, 8 may in this connection be configured to comprise an electric-photonic cointegrated chip, the so-called EPIC chip 19. For the cointegration, for example, a silicon-photonic technology is used. This facilitates the monolithic integration of photonic components, high-frequency electronics, and digital electronics together on one chip, which is also referred to as electronic-photonic cointegration. The technical innovation of such a system in this connection consists in the signal transmission of gigahertz signals by an optical carrier signal in the terahertz frequency range. The electronic computing device 9 in this connection generates an optical carrier frequency. On the same the signal to be transmitted is modulated with an eighth of the radar frequency and transmitted per optical fiber 20 to the EPIC chip 19. On the same an eightfold increase of the frequency occurs so that the radiation of the EPIC chip 19 may be emitted in its original form. Signal detection analogously takes place in the reverse way. All data are processed on the electronic computing device 9.

By the large surface distribution of the EPIC chips 19 on the vehicle surface and the coherent signal processing of the individual antenna elements 6, 7, 8 the resolution capacity in the range of 0.1 degree may be refined.

FIG. 8 shows a schematic block diagram according to an embodiment of the antenna device 5. In particular, three different antenna devices 5 are shown or the antenna devices 5 are shown in different situations. Further a plurality of antenna elements 6, 7, 8 are shown. In the present case it is shown that the corresponding antenna elements 6, 7, 8 may be activated or deactivated, respectively, separately from each other. In particular, it is thereby facilitated that, based on the activation of at least the first antenna element 6 and/or the second antenna element 7 a predetermined radiation characteristic 21 and/or receiving characteristic is set.

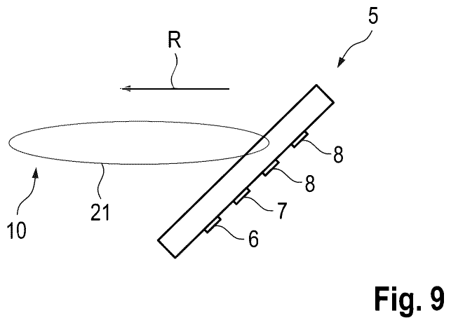

FIG. 9 shows a further schematic side view according to an embodiment of the antenna device 5. In the present case, it is shown that the antenna device 5 relative to a longitudinal axis x of the transportation vehicle 1 and a vertical axis z, which corresponds to a vertical axis of the transportation vehicle 1, is represented tilted. As an example it may be envisaged that the antenna device 5 is configured within an A pillar of the transportation vehicle 1. In the present case it is shown that, based on the control signal and based on a predetermined alignment of liquid crystals in the at least first antenna element 6 and/or the second antenna element 7 a radiation direction R for transmitting and/or receiving the electromagnetic radiation 10 are set. In particular, based on the installation place of the at least one antenna element 6 and/or the second antenna element 7 the radiation direction R and/or receiving direction may by predetermined. Further, also based on a purpose of employment the antenna device 2 the radiation direction R and/or receiving direction may be predetermined.

In the following example, for instance, the antenna device 5 may be configured as radar device 3. In particular, thus the emitting of the electromagnetic radiation 10 occurs substantially in parallel to the x axis. For example, the antenna device 5 should be configured as the antenna device 5 as communication device 4 for communication with a communication satellite, the radiation direction R may occur substantially in parallel to the z axis.

The antenna device represented in FIGS. 1 to 9, in particular, has the benefit that a simple recalibration of the antenna device 5 may be effected by shifting the antenna elements 6, 7, 8 on the basis of the liquid crystal technology 11. Further, a random interconnection of the individual antenna elements 6, 7, 8 may be effected. Thereby the reduction of ambiguities based on the field of view may be realized. Further, a reduction of the necessary voltage for switching the antenna device 5 may occur. Further, a freely configurable antenna arrangement, that is the switching between different configurations, for example, long range, mid range, or short range, to a single antenna device 5, is facilitated. Further, a reconfiguration of the antenna device 5 upon failure of individual antenna elements 6, 7, 8 is given so that the antenna device 5 need not be exchanged. Further, this is a cost-efficient manufacturing option of large surface antenna devices 5 and a refinement of the resolution capacity of the antenna device 5. Further, a polarization-sensitive detection as well as a manufacture suitable for batch production may be realized since the liquid crystal technology 11 is already sufficiently known from the prior art. Further, a saving of construction space as well as the covered installation is realizable since the at least substantially transparent design of the antenna elements 6, 7, 8 is facilitated.

Further, the method/antenna device 5 may also be applied to Lidar, camera, as well as further employment options.

### LIST OF REFERENCE SIGNS

1 transportation vehicle
2 assistance system
3 radar device
4 communication device
5 antenna device
6 first antenna element
7 second antenna element
8 further antenna element
9 electronic computing device
10 electromagnetic radiation
11 liquid crystal technology
12 substrate
13 first polarizer
14a electrode
14b electrode
15 second polarizer
16 high frequency antenna
17 first LC layer
18 second LC layer
19 EPIC chip
20 optical fiber
21 radiation characteristic
R radiation direction
X longitudinal axis
Z vertical axis

1. An antenna device for a transportation vehicle for emitting and/or receiving electromagnetic radiation, the antenna device comprising:
at least one first antenna element configured to emit and/or receive the electromagnetic radiation based on a liquid crystal technology;
an electronic computing device configured to generate a control signal for controlling the at least first antenna element; and
at least one second antenna element configured to emit and/or receive the electromagnetic radiation based on the liquid crystal technology,
wherein the at least one first antenna element and/or the at least one second antenna element are activated for emitting and/or receiving based on the control signal generated by the electronic computing device.

2. The antenna device of claim 1, wherein at least one of the at least one first antenna element and the at least one second antenna element are configured to be activated separately from each other.

3. The antenna device of claim 1, wherein the antenna device further comprises a plurality of further antenna elements, wherein the plurality of further antenna elements are configured to be activated based on the control signal generated by the electronic computing device.

4. The antenna device of claim 1, wherein at least the first antenna element and/or the at least one second antenna element are substantially transparent.

5. The antenna device of claim 1, wherein the antenna device is configured at least partially in a window pane of the transportation vehicle.

6. The antenna device of claim 5, wherein the antenna device is configured at least partially in a windshield and/or in a rear window and/or in a side window and/or in a roof window.

7. The antenna device of claim 1, wherein the antenna device is configured as part of a radar device of the transportation vehicle and/or as part of a communication device of the transportation vehicle.

8. The antenna device of claim 1, wherein a predetermined radiation characteristic and/or receiving characteristic is set based on an activation of at least one of the at least one first antenna element and/or the at least one second antenna element.

9. The antenna device of claim 1, wherein a radiation direction for transmitting and/or a receiving direction for receiving the electromagnetic radiation are set based on the control signal generated by the electronic computing device and/or a predetermined orientation of liquid crystals in at least one of the at least one first antenna element and at least one second antenna element.

10. The antenna device of claim 9, wherein the radiation direction and/or receiving direction is predetermined based on an installation location of the at least one first antenna element and/or the at least one second antenna element.

11. The antenna device of claim 9, wherein the radiation direction and/or receiving direction is predetermined based on a purpose of employment of the antenna device.

12. A communication device comprising the at least one antenna device of claim 1.

13. A radar device comprising the at least one antenna device of claim 1.

14. An assistance system comprising at least one communication device and/or comprising a radar device, wherein the at least one communication device and/or the radar device include at least one antenna device of claim 1.

15. A method for operating an antenna device for a transportation vehicle for emitting and/or receiving electromagnetic radiation, the method comprising:
emitting and/or receiving electromagnetic radiation using at least one first antenna element based on a liquid crystal technology; and
controlling the at least one first antenna using an electronic computing device by which a control signal for the at least first antenna element is generated to control the at least one first antenna,
wherein the antenna device comprises at least one second antenna element, by which electromagnetic radiation is emitted and/or received based on the basis of the liquid crystal technology, and
wherein the at least one first antenna element and/or the at least one second antenna element are activated for emitting and/or receiving based on the control signal generated by the electronic computing device.

16. The method of claim 15, wherein at least one of the at least one first antenna element and the at least one second antenna element are configured to be activated separately from each other.

17. The method of claim 15, wherein the antenna device further comprises a plurality of further antenna elements, wherein the method further comprises activating the plurality of further antenna elements based on the control signal generated by the electronic computing device.

18. The method of claim 15, further comprising setting a predetermined radiation characteristic and/or receiving characteristic based on an activation of at least one of the at least one first antenna element and/or the at least one second antenna element.

19. The method of claim 15, further comprising setting a radiation direction for transmitting and/or a receiving direction for receiving the electromagnetic radiation are set based on the control signal generated by the electronic computing device and/or a predetermined orientation of liquid crystals in the at least one of the at least one first antenna element and/or at least one second antenna element.

20. The method of claim 19, wherein the radiation direction and/or receiving direction is predetermined based on an installation location of the at least one first antenna element and/or the at least one second antenna element.

21. The method of claim 19, wherein the radiation direction and/or receiving direction is predetermined based on a purpose of employment of the antenna device.
